(19) United States
(12) Patent Application Publication
(10) Pub. No.: US 2006/0085990 A1
(43) Pub. Date: Apr. 27, 2006

(54) Drive handle and power saw for carving soft materials

(75) Inventors: Kurt Van Ulmer, Denver, CO (US); Justin Discoe, Windsor, CO (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Rauch Industries, Inc., Gastonia, NC (US)

(21) Appl. No.: 11/236,473

(22) Filed: Sep. 27, 2005

Related U.S. Application Data
(60) Provisional application No. 60/613,676, filed on Sep. 27, 2004.

(51) Int. Cl. B26B 15/00

(52) U.S. Cl. 30/277.4

(57) ABSTRACT

The present invention relates to a portable power tool, wherein the portable power tool is used to carve soft materials. The portable power tool comprises a drive handle, wherein the drive handle has an interior space. A carving tool retaining storage area is situated within the interior space of the drive handle. The carving tool retaining area further comprising a carving tool retaining mechanism, the carving tool retaining mechanism being used for the releasable retaining of a carving tool in the carving tool storage area. The drive handle also comprises a detachable access panel that allows access to the interior space of the drive handle, thus allowing for the mounting and demounting of a cutting tool within the interior space of the drive handle.

This application claims the benefit, pursuant to 35 U.S.C. §119(e), of U.S. Provisional Patent Application entitled “DRIVE HANDLE AND POWER SAW FOR CARVING SOFT MATERIALS,” filed on, Sep. 27, 2004 and assigned Ser. No. 60/613,676, the disclosure of which is incorporated herein by reference in its entirety.

### FIELD OF THE INVENTION

The present invention generally relates to tools that may be used to cut relatively soft materials. More particularly, the present invention relates to instruments that may be used to carve decorative features into soft shell materials (e.g., pumpkins, squash, gourds, watermelons, etc.).

### BACKGROUND OF THE INVENTION

A wide variety of cutting tools have long been known, and many such cutting tools are mechanically driven, for example, by electric motors. On one hand, these power tools may have a power cord that may be plugged into an electrical outlet. On the other hand, it is known that these power tools may be battery operated, as well. Many such power tools are robust so as to handle heavy-duty cutting jobs. Such tools include a variety of power saws, drills, and the like.

Naturally, traditional power tools are not usually the type that may be used to cut soft materials such as the fleshy shells of fruits which include, for example, pumpkins, watermelons, squash, gourds, etc. Often, people desire to carve such fruits with decorative features, especially to celebrate festival holidays such as Halloween, Thanksgiving and even the Fourth of July. Traditionally, the carving of features into these fruits has been accomplished by employing manually operated tools.

For a long time, such carving was done with pocketknives, paring knives and the like. Due to the size of these cutting instruments, a typical carver was only able to obtain limited, fairly large-scale decorative features. In more recent years, however, new techniques and tools were developed to carve more elaborate and decorative features into the shell of the fruit, especially pumpkins. These techniques were spurred by the introduction of the pumpkin carving kit that was developed and described in U.S. Pat. No. 4,828,114 issued to Bardeen. This kit included manually operated drills and saws having fine-toothed, small-dimensioned blades that could be used for more detailed cutting. An example of such a saw may be found the '114 patent, with a more detailed example of such a saw being taught in U.S. Pat. No. 4,841,638 issued to Bardeen et al.

Where a person seeks to carve a large number of fruits or carve very large and elaborate designs in the fruits, the use of hand operated saws can be tiresome and in some instances, somewhat frustrating. For example, as the user provides a vertical reciprocating motion, to create the sawing action, the user must also apply a forward motion in the cutting direction to move the blade against the material to be cut. Sometimes, this multiple action is difficult, and the user does not apply a uniform forward force or a uniform reciprocating force. This can frustrate the users ability to cut clean, even lines. Where intricate features are being carved such non-uniform force can create uneven cut lines and can even inadvertently tear the soft material that is being cut thereby ruining the carved design.

Accordingly, there remains a need for improved cutting tools that may be used to cut soft materials. There is a need for sure tools that can cut the soft shell material of fruits, such as pumpkins, squash, gourds, watermelons and the like. There is a special need for such a tool that may be power operated. In addition, there is a desire that such a tool be able to employ existing tools that are used in the carving of delicate features in such soft shell materials.

### SUMMARY

The present invention generally relates to tools that may be used to cut relatively soft materials. More particularly, the present invention is directed to saws that may be used to carve decorative features into soft shell materials such as pumpkins, squash, gourds, watermelons or other fruits. Specifically, the present invention relates to a drive handle and power saw for carving such soft materials.

An embodiment of the present invention relates to drive handle that is implemented within a portable power tool, wherein the portable power tool is used to carve soft materials. The drive handle has an interior space, within the interior space is situated a carving tool retaining storage area. The carving tool retaining area further comprises a carving tool retaining mechanism, the carving tool retaining mechanism being used for the releasable retaining of a carving tool in the carving tool storage area. The drive handle also comprises a detachable access panel that allows access to the interior space of the drive handle, thus allowing for the mounting and demounting of a cutting tool within the interior space of the drive handle.

Further aspects of the drive handle allow for the drive handle to be configured to receive and supportably mount a cutting tool within the drive handle. Also a drive motor device is situated within the drive handle, the drive motor device being in mechanical communication with the cutting tool, wherein the drive motor device being configured to move the cutting tool in a reciprocating longitudinal direction.

Additional aspects of the present provide the drive handle to comprise a power source, wherein the power source is in electrical communication with the drive motor device. Yet additionally, aspects of the present invention allow for a pre-existing manually operated longitudinally extending cutting tool to be mounted within the drive handle.

An additional embodiment of the present invention relates to a portable power tool for carving soft materials. The power tool comprises a drive handle, the drive handle having an interior space and further comprising a carving tool retaining storage area with a carving tool retaining mechanism for the releasable retaining of a carving tool. Further aspects of the present invention provide for the cutting tool to comprise a pre-existing manually operated longitudinally extending cutting tool.

The drive handle further comprises a detachable access panel that is detachable from the drive handle in order to allow access to the interior space of the drive handle, thus allowing for the mounting and demounting of a cutting tool within the interior space of the drive handle. Additionally the drive handle comprises a cutting tool, wherein the cutting tool is received and supportably mounted within the drive handle. A drive motor device is also situated within the drive handle, wherein the drive motor device is in mechanical communication with the cutting tool, the drive motor device being configured to move the cutting tool in a reciprocating longitudinal direction. Further aspects of the portable power tool provide for the drive handle to comprise a power source, the power source being in electrical communication with the drive motor device.

Therefore, in view of the above descriptions, it is an object of the present invention to provide a new and useful drive handle and power saw that may be used for carving soft materials. It is another object of the present invention to provide a battery operated drive handle that can mount pre-existing carving tools so as to provide the automatic reciprocation of those tools in the manner of a power saw.

These and other objects of the present invention will become more readily appreciated and understood from a consideration of the following detailed description of the exemplary embodiment of the present invention when taken together with the accompanying drawings.

### BRIEF DESCRIPTION OF THE DRAWINGS

FIG. 1 is a perspective view of a power saw according to the exemplary embodiment of the present invention.

FIG. 2 is a perspective view of a prior art handheld saw of the type that is to be received by the drive handle of FIG. 1 according to the exemplary embodiment of the present invention.

FIG. 3 is a side view in elevation of a drive handle of the power saw of the present invention.

FIG. 4 is a top plan view of the drive handle of FIG. 3.

FIG. 5 is an end view in elevation of the drive handle of FIGS. 3 and 4.

FIG. 6 is a side view in elevation of the drive handle of FIGS. 3-5 with a section of the case removed there from to illustrate the internal components thereof.

FIG. 7 is an enlarged side view in elevation showing the distal end portion of the drive handle of FIG. 6 with the carriage member removed so as to reveal the gear drive and guide member therefore.

FIG. 8 is a perspective view of the gear drive and drive member of FIG. 7.

FIG. 9 is a perspective view of the carriage member that mounts in the guide member of FIGS. 7 and 8 for sliding, reciprocating movement.

FIG. 10 is a bottom plan view with the carriage member of FIG. 9.

FIG. 11 is a side view in elevation of the distal end portion of the drive handle illustrating the mounting of the handheld tool FIG. 2 in the carriage member of FIGS. 9 and 10.

### DETAILED DESCRIPTION

The present invention is particularly directed to carving decorative items into the soft, fleshy shells of fruits such as pumpkins, squashes, watermelons, gourds and the like. However, it should be understood that the present invention may be also used for the carving or cutting of other soft materials.

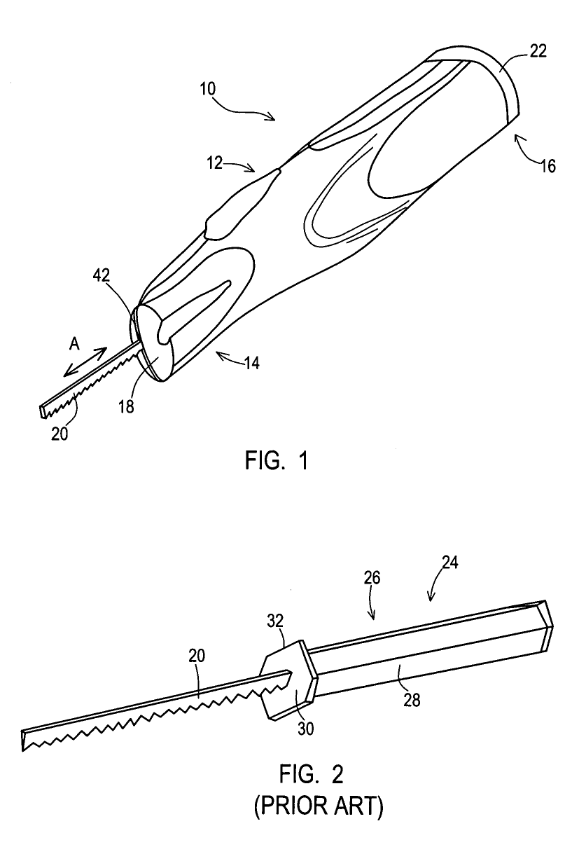

Accordingly, power saw 10 according to the exemplary embodiment of the present invention is introduced in FIG. 1. The power saw 10 comprises a drive handle 12 having a forward end portion 14 and a rearward end portion 16. Forward end portion 14 terminates in a nose 18 having an opening 42 through which a saw blade 20 extends in a longitudinal direction with saw blade 20 being driven reciprocally in the direction of arrow “A” by drive handle 12, as described more thoroughly below. An end cap 22 covers the rearward end portion 16 and is provided to allow access to a battery compartment enabling the user to replace the power source in the form of batteries received therein.

Drive handle 12 is adapted to mount a handheld saw or other tool that is of the type known in the art. Such a tool is illustrated in FIG. 2 as a handheld saw 24 that includes an elongated handle 26 that mountably supports the longitudinally extending saw blade 20. Handle 26 includes a body portion 28 which as presently illustrated is hexagonal in cross-section. Handle 28 terminates in a forward flange 30 that is slightly larger in dimension so as to provide a rim 32 extending there around. The handle 26 is normally grasped manually by a user so as to manually reciprocate saw blade 20 during the carving of soft materials, such as a pumpkin shell, for creating decorative images therein. The drive handle 12 is adapted to receive a tool, such as saw 24, in order to provide a power drive to the tool. It should be understood that the present invention is contemplated for use with such handheld saws, although other tools, if configured to have a handle similar to handle 26 may be operated as well. As noted below, modification of the carriage member could allow the use of differently configured handheld tools.

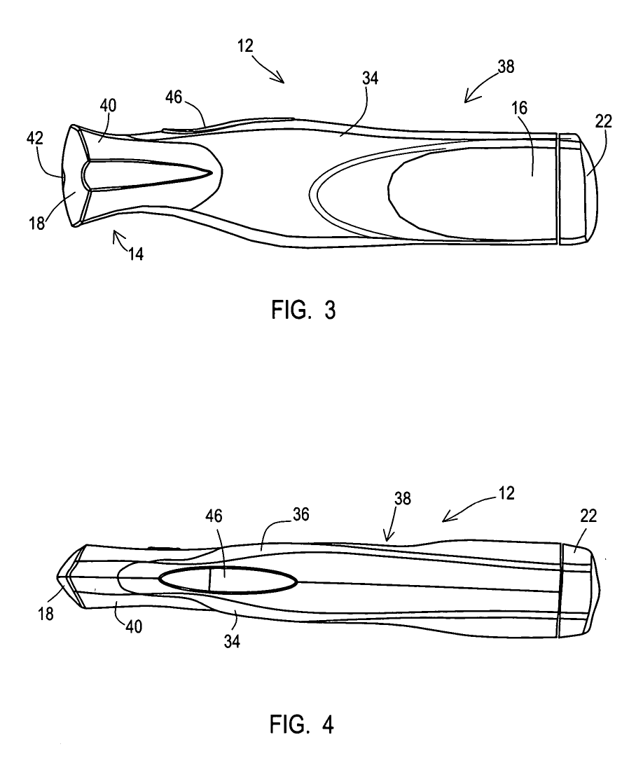

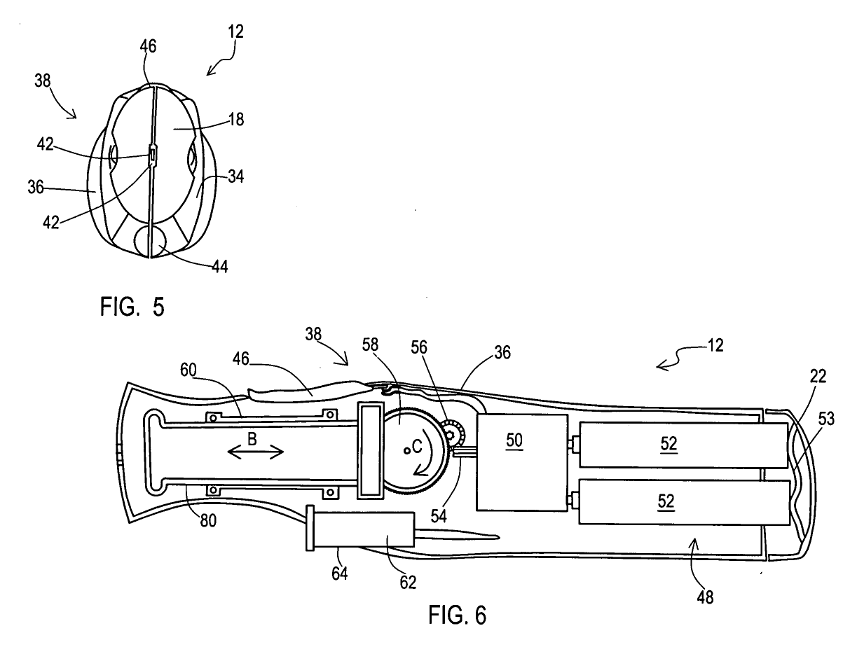

The external components of drive handle 12 are illustrated in FIGS. 3-5. As illustrated in FIGS. 3-5, the drive handle 12 is constructed as two mating sections 34 and 36 that form a case therefore. Handle sections 34 and 36 may be snap fit together or otherwise secured in any convenient manner known in the art. Preferably, handle sections 34 and 36 are formed of injection molded plastic or other suitable material. As noted above, the end cap 22 is mounted on the rearward portion 16 of drive handle 12 in order to allow access to the battery compartment, wherein the end cap 22 is configured to be removable from the reward portion 16 of the drive handle 12. A forward end portion 14 of drive handle 12 is provided with a transparent access panel 40 that is removable from the drive handle 12 in order to allow access to the interior of case 38 thereby to allow mounting and demounting of handheld saw 24 therein. Moreover, as is illustrated in FIG. 5, the nose 18 has a rectangular opening 42 that accommodates the saw blade 20 for unrestricted longitudinal reciprocal movement of the saw blade 20. Also, with reference to FIG. 5, an optional opening 44, shown in phantom, may be provided to allow storage of a poker tool such as those known in the art and as illustrated in FIG. 6. A switch button 46 is also supported by case 38 so that the user, by depressing switch button 46 may activate the drive handle for powered reciprocation of saw blade 20 and which, upon release acts to shut the drive handle into an off condition.

The internal components of drive handle 12 are illustrated in FIG. 6 wherein drive handle 12 is depicted with the handle section 34 and access panel 40 removed from the drive handle 12. In this illustration, end cap 22 is shown in cross-section. Here, it may be seen that case 38 supports a centrally located battery operated drive motor 50 that is powered by batteries 52 received in battery compartment 48. The end cap 22 includes a contact bridge 52 that both acts as a spring to mount batteries 52 as well as to establish electrical communication so that the batteries 52 are electrically connected in series. The motor 50 comprises a pinion gear that is used as an output drive gear 54 that turns a crown gear that is part of a reduction gear 56 that in turn drives a geared crank 58. Reduction gear 56 and geared crank 58 are mounted for supported rotational movement with respect to handle section 36. The ordinarily skilled person in this field could make other mechanical arrangements depending upon the drive motor and the desired speed of reciprocation.

The forward end portion of drive handle 12 includes a guide member 60 that is mounted to handle section 36 and which supports a carriage member 80 for reciprocal movement in the direction of arrow “B” when gear crank 58 is rotated in the direction of arrow “C”. As noted above, an optional opening is provided to receive a prior art poking tool, such as poking tool 62 illustrated in FIG. 6. To this end, spring clip 64 may also be provided to releasably retain the poking tool 62 in a stored state. A user may withdraw poking tool 62 to create holes in the material to be carved so that saw blade 20 may be introduced into such holes. Alternatively, saw blade 20 may itself be used to poke through the material to start the cutting operation.

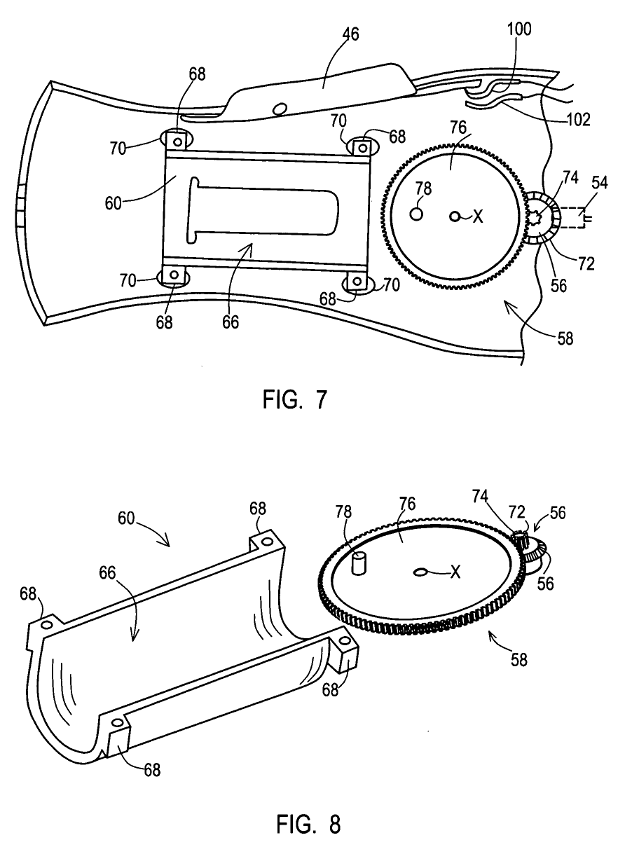

With reference now to FIGS. 7 and 8, the drive train and guide member 60 is illustrated in greater detail. In these figures, it may be seen that guide member 60 is trough-shaped in configuration so as to have a longitudinal extending slide way 66 therein. Guide member 60 includes a plurality of ears 68 that may be mounted on bosses 70 by any suitable means, such as screws and the like. Reduction gear 56 is driven by drive gear 54 (shown in phantom) and includes a first gear element 72 driven by drive gear 54 and a reduction gear element 74. Reduction gear element 74 engages the teeth of crank gear 76 that is provided with a crank pin 78. Together, crank gear 76 and crank pin 78 make up geared crank 58.

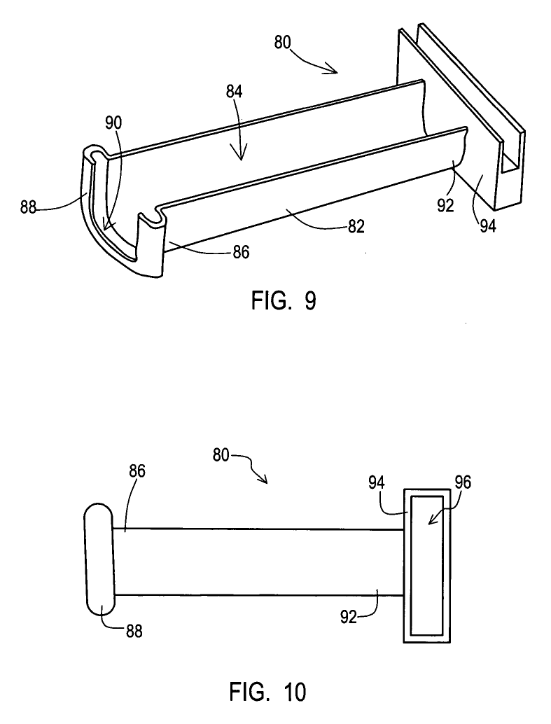

Geared crank 58 acts to reciprocate carriage member 80. To this end, carriage member 80 is best illustrated in FIGS. 9 and 10. It may be seen that carriage member 80 includes a longitudinally extending body 82 that is sized and adapted for supported, reciprocal movement in slide way 66 of guide member 60. Body 82 is therefore trough-shaped in configuration so as to have a longitudinally extending bay 84 that is sized and adapted to receive handle 26 of handheld saw 24. Forward end 86 of carriage member 80 terminates in a lip 88 that extends around the perimeter thereof and which is provided by an inwardly facing groove 90 that is sized and adapted to receive flange 30 of handle 26 of handheld saw 24. Rearward end 92 of carriage member 80 includes a cross-bar 94 that has a transverse slot 96 that is sized to engage crank pin 78 of geared crank 58 when carriage member is mounted in slide way 66 of guide member 60. Accordingly, as crank pin 78 revolves around gear axis “X,” shown in FIGS. 7 and 8, crank pin 78 will reciprocally drive carriage member 80 as it reciprocates in transverse slot 96. Reduction gear 56 and crank gear 76 are selected so as to increase torque and reduce speed from the drive gear 54 of motor 50.

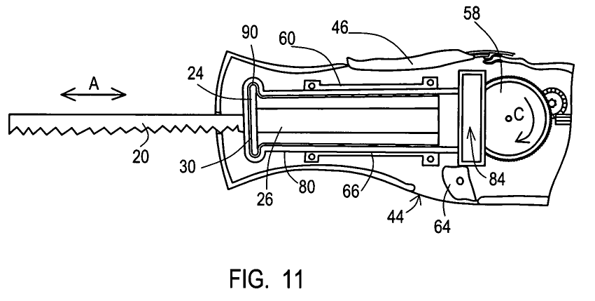

The assembly of these components may be further appreciated with reference to FIG. 11. FIG. 11 shows that the handle 26 of handheld saw 24 is mounted in bay 84 of carriage 80. Flange 30 is received in groove 90 so that handheld saw 24 is secured for corresponding movement with carriage member 80. The carriage member 80 is mounted in slide way 66 of guide member 60, and it should be understood that crank pin 78 resides in slot 96 of carriage member 80. Rotation of crank gear 58 acts to reciprocally drive carriage member 80 and thus reciprocate saw blade 20 in the direction of arrow “A”. This occurs, of course, when an electrical connection is made between contacts 100 and 102, illustrated in FIGS. 7 and 11 that occurs upon depressing switch button 46.

While the carriage member 80 has been described herein with a configuration to receive the handle of saw 24, it should be understood by the skilled person in this field that the structure of carriage member 80 could be modified to correspond to differently shaped hand held tools. Of course, depending upon modifications to carriage member 80, it might also be necessary to modify the structure of guide member 60. However, it is believed that such modifications would be within the normal ordinary skill of such persons.

Accordingly, the present invention has been described with some degree of particularity directed to the exemplary embodiment of the present invention. It should be appreciated, though, that modifications or changes may be made to the exemplary embodiment of the present invention without departing from the inventive concepts contained herein.

What is claimed:

1. A drive handle for a portable power tool for the carving of soft materials, wherein the drive handle comprises:
an interior space;
a carving tool retaining storage area with a carving tool retaining mechanism for the releasable retaining of a carving tool;
a detachable access panel that is detachable from the drive handle in order to allow access to the interior space of the drive handle, thus allowing for the mounting and demounting of a cutting tool within the interior space of the drive handle;

2. The drive handle of claim 1, wherein the drive handle is configured to receive and supportably mount a cutting tool within the drive handle.

3. The drive handle of claim 2, wherein a drive motor device situated within the drive handle, the drive motor device being in mechanical communication with the cutting tool, further, the drive motor device being configured to move the cutting tool in a reciprocating longitudinal direction.

4. The drive handle of claim 3, wherein the drive handle comprises a power source, the power source being in electrical communication with the drive motor device.

5. The drive handle of claim 4, wherein the cutting tool comprises a pre-existing manually operated longitudinally extending cutting tool.

6. The drive handle of claim 4, wherein the power source comprises at least one battery.

7. The drive handle of claim 4, wherein the detachable access panel comprises a detachable transparent access panel.

8. A portable power tool for carving soft materials, wherein the power tool comprises:
a drive handle, wherein the drive handle having an interior space, the drive handle further comprising:
a carving tool retaining storage area with a carving tool retaining mechanism for the releasable retaining of a carving tool;
a detachable access panel that is detachable from the drive handle in order to allow access to the interior space of the drive handle, thus allowing for the mounting and demounting of a cutting tool within the interior space of the drive handle;
a cutting tool, wherein the cutting tool is received and supportably mounted within the drive handle; and
a drive motor device situated within the drive handle, wherein the drive motor device is in mechanical communication with the cutting tool, the drive motor device being configured to move the cutting tool in a reciprocating longitudinal direction.

9. The portable power tool of claim 1, wherein the drive handle comprises a power source, the power source being in electrical communication with the drive motor device.

10. The portable power tool of claim 9, wherein cutting tool comprises a pre-existing manually operated longitudinally extending cutting tool.

11. The portable power tool of claim 10, wherein the power source comprises at least one battery.

12. The portable power tool of claim 11, wherein the detachable access panel comprises a detachable transparent access panel.
